(19) United States
(12) Patent Application Publication
(10) Pub. No.: US 2008/0313865 A1
(43) Pub. Date: Dec. 25, 2008

(54) Deck fastener hinged clip

(76) Inventor: Anastasios George Hatsios, Buffalo, NY (US)

Correspondence Address: George Hatsios, 773 Woodstock Avenue, Tonawanda, NY, 14150, US

(21) Appl. No.: 12/214,839

(22) Filed: Jun. 23, 2008

Related U.S. Application Data
(60) Provisional application No. 60/937,173, filed on Jun. 25, 2007.

(51) Int. Cl. F16G 11/06

(52) U.S. Cl. 24/135 R

(57) ABSTRACT

A Pre-Assembled Deck Panel to Support Cable Hinged Fastener Clip for installation upon temporary elevated work decks and comprised of a rod-shaped similar to a hook, a hinged cover plate and a hex nut. The cover plates are attached together as a hinge with a pin so that the cover plates move as a hinge. The rod is threaded on the hooked end and attached to one of the hinge plates so that when the two plates move as a hinge, the threaded end of the hooked rod protrudes up through a hole in the corresponding hinge plate and secures the support cable and the deck panel together. A hex nut is then placed onto the protruding threaded end of the hooked rod to temporarily secure the hinge plates into the position of securing the deck panel to the support cable.

### CROSS-REFERENCE TO RELATED APPLICATIONS

This application claims the benefit of U.S. Provisional application No. 60/937,173, filed Jun. 25, 2007, entitled “DECK FASTENER HINGED CLIP”, by inventor Anastasios George Hatsios, and herein incorporated by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates to work deck platform systems which are installed temporarily under or upon structures such as bridges to allow workers and equipment to repair and renovate said structure and more particularly to an improved fastener clip for securing deck panels upon support cables to allow for faster, easier and safer installation of the work deck platform and better debris containment.

Current temporary work platform deck floor panels are secured to wire rope support cables in several ways. One common means is through holes cut into the corrugated deck panels to allow U-shaped bolting hardware to be inserted through the hole to grab onto the cable and an oversized washer or plate covers the hole and is attached to the U-bolt with a nut to secure the deck panel to the support cable.

The fastening hardware of known current means consists of multiple parts which must be assembled by the worker and then held in place until securely tightened using hand tools. With the fastening hardware consisting of multiple parts the installation process is awkward, as the worker must assemble the hardware, then hold it in place while also grabbing the hand tools and tightening the hardware.

The installation process is time consuming and there is also opportunity for pieces of hardware to be dropped during installation allowing metal to fall to the ground, highway or water below creating a danger to motorists, persons and property below.

Also work deck platforms are normally installed at elevated heights where workers have a limited surface area to stand upon and work from and whereby the less equipment and movement required the easier and safer their job becomes.

Though care is taken to keep the holes covered, debris inevitably escapes the enclosed work area through these holes in the deck floor panels. Fastening hardware which completely covers the opening in the deck panel would be desirable.

### BRIEF SUMMARY OF THE INVENTION

It is the object of this invention to provide a pre-assembled deck panel to support cable, hinged fastener clip, which can be used to secure work deck platform floor panels upon wire rope support cables without having to assemble the fastener clip on location.

It is another object of this invention to provide a deck panel to support cable, hinged fastener clip, which better prevents dust and debris from escaping outside the containment area by completely covering the securing hole in the work deck platform floor panel through which the fastener clip is inserted.

In summary the deck panel to support cable, hinged fastener clip of this invention consists of two plates, attached together as a hinge, a pin holding the plates together to complete the hinge and a rod partially bent to shape approximately like a hook with the end of the hook threaded, and a hex nut. Though exact hardware dimensions may vary the general shape of the hooked rod remains approximately the same so that when the non-hooked part of the rod is attached to the underside of one of the hinge plates with the hooked end extending towards the corresponding hinge plate; the hook shaped portion of the rod is shaped to grasp partially around a cable with the threaded end of the hooked rod protruding up through a hole in the corresponding hinge plate. The hex nut is then threaded onto the protruding threaded end of the hooked rod to keep it in place. For example purposes, though dimensions need not be exact the hinge plates of this invention when attached together as a hinge are approximately 1.5 inches wide by 0.1250 inches thick by 9.0 inches long. One hinge plate is approximately 5.5 inches long with a 0.625 inch hole located 3.5 inches from the end opposite the hinge pin along the centerline. The hinge plate forming the other side of the hinge is approximately 3.5 inches long. The steel hooked rod is approximately 4 inches long by approximately 0.442 inches diameter with approximately a 0.625 inch length of one end threaded. The Hooked Rod is bent 60-degrees approximately 1.3125 inches from the tip of the threaded end and bent in opposite direction 30-degrees approximately 2.17 inches from the centerline of the threaded end after the first bend is made. The hinge pin is standard length and diameter so as to hold the two hinge plates together. The hex nut is standard size and threading needed to thread onto the threaded end of the hooked rod.

The two hinge plates are attached together with a hinge pin as you would a common hinge. The hinge is then placed with both plates laying flat on the same general plane and so that the hinge pin portion of the plates is facing up. The hooked rod is attached at the non-threaded end to the underside of the 3.5 inch hinge cover plate so that the threaded tip of the hooked rod protrudes up thru the 0.625 inch hole in the 5.5 inch hinge plate when the entire hinge plate assembly is placed flat with both sides of the hinge opposite one another and on the same general plane.

### BRIEF DESCRIPTION OF THE SEVERAL VIEWS OF THE DRAWING

FIG. 1. Is a fragmentary elevated side view of a typical work platform consisting of wire rope support cable 200 and corrugated steel deck panels 300 installed under a bridge structure 10, 11, 12 and 15.

FIG. 2. Is a side view of the Hinged Fastener Clip in the secured position showing the threaded end of the hooked rod 101a protruding through the hole in the cover plate 107 with the hex nut 108 attached.

FIG. 3. Is an alternate plan view of the Hinged Fastener Clip of FIG. 2.

FIG. 4. Is a side view of the Hinge Fastener Clip of FIG. 2 with deck panel 300 and wire rope support cable 200 shown.

FIG. 5. Is a side view of another possible version of the Hinged Fastener Clip showing the hinge plates 102 and 103 and the cover plates 104 and 105 as different pieces of hardware unlike the version of FIG. 4 where the cover plate is also the hinge plate 106 and 107

FIG. 6. Is a side view of the Hinged Fastener Clip of FIG. 4 in the open position with hex nut 108 not attached showing direction of movement of the hooked rod 101 and hinge plate from open to the secure position.

FIG. 7. Is an alternate plan view of the Hinged Fastener Clip of FIG. 4 showing the corrugated deck panel 300 and the wire rope support cable 200.

FIG. 8. Is an alternate side view of the Hinged Fastener Clip of FIG. 7.

FIG. 9. Is a side view of a section of the work deck platform with wire rope support cable 200, corrugated deck panel 300, hinged fastener clip 100 and showing a partial view of a worker standing on platform.

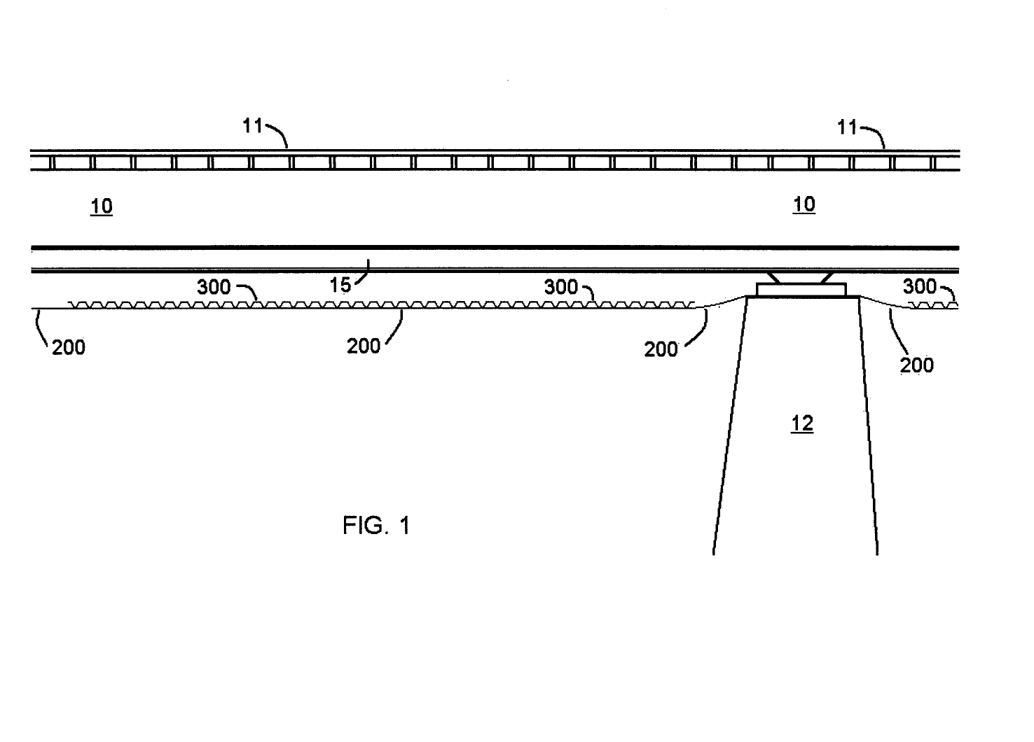

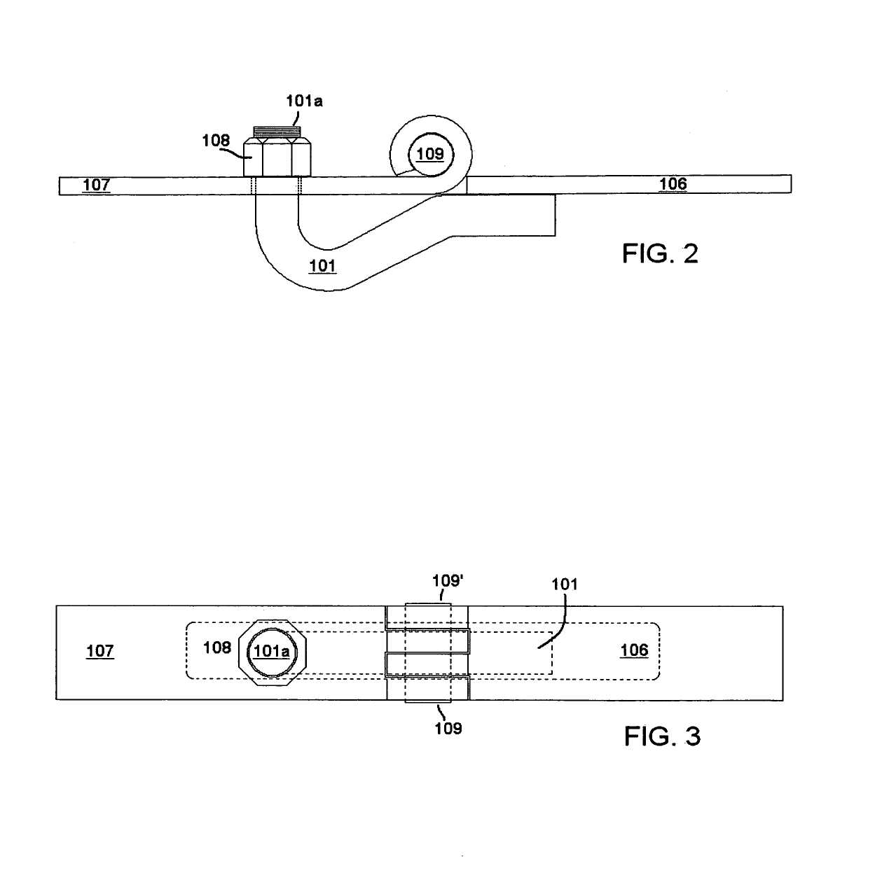

### DETAILED DESCRIPTION OF THE INVENTION

Referring to FIG. 2 there is shown a side view of the Hinged Fastener Clip of this invention which is comprised of the hinge plates 106 and 107 connected together with a pin 109 to form a hinge. The steel rod 101 is attached to the underside of one of the hinge plates 106 and has a hooked shaped portion which extends towards the second hinge plate 107. The end of the hooked portion of the rod is threaded 101a and protrudes up through an opening in the second hinge plate 107. A hex nut 108 is placed onto the threaded end of the hooked rod 101a to temporarily secure the hooked rod 101 to the hinge plate 107.

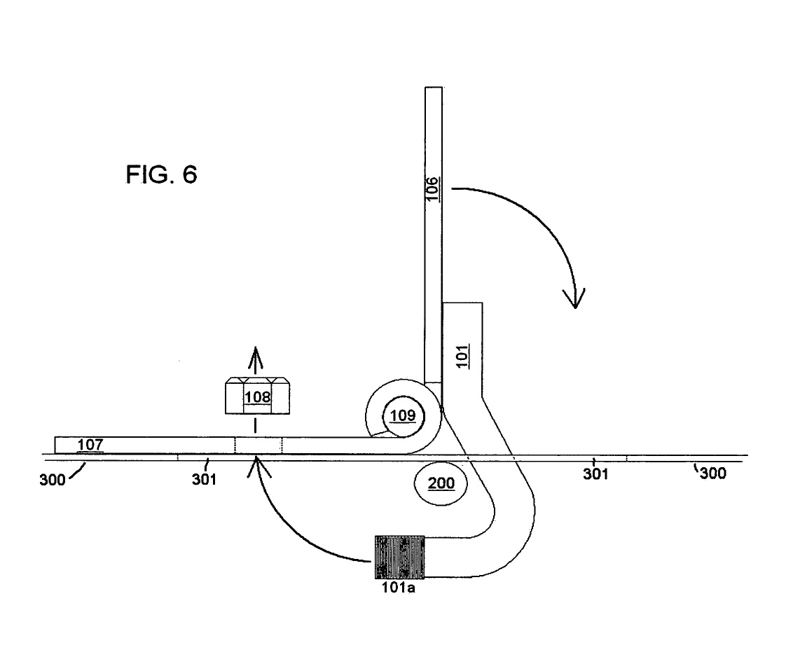

Referring to FIG. 6 there is shown a typical movement of the hinge plate 106 and hooked rod 101 of the Hinged Fastener Clip when the Hinged Fastener Clip is placed upon a deck panel 300 to secure said deck panel 300 to a support cable 200.

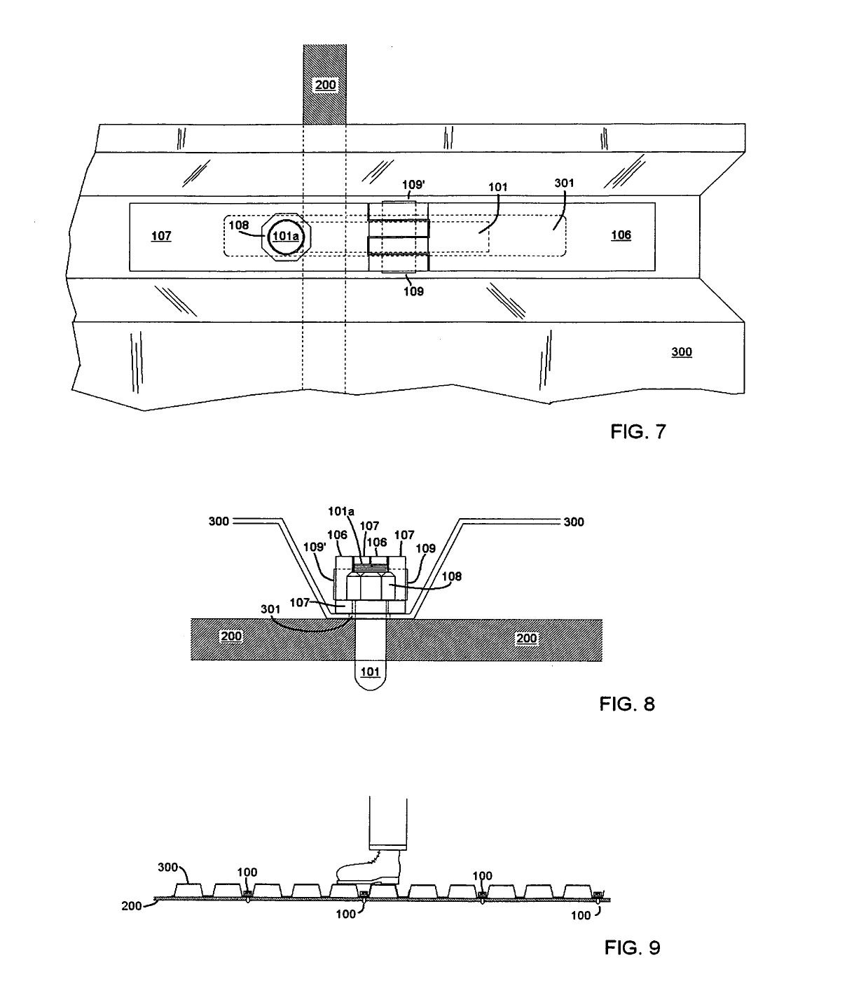

As can be seen in FIG. 7 the hinge plates 106 and 107 are larger then the slotted opening 301 in the deck panel 300 thus completely cover the slotted opening 301 and preventing the Hinged Fastener Clip from completely passing through the slotted opening 301 of the deck panel 300.

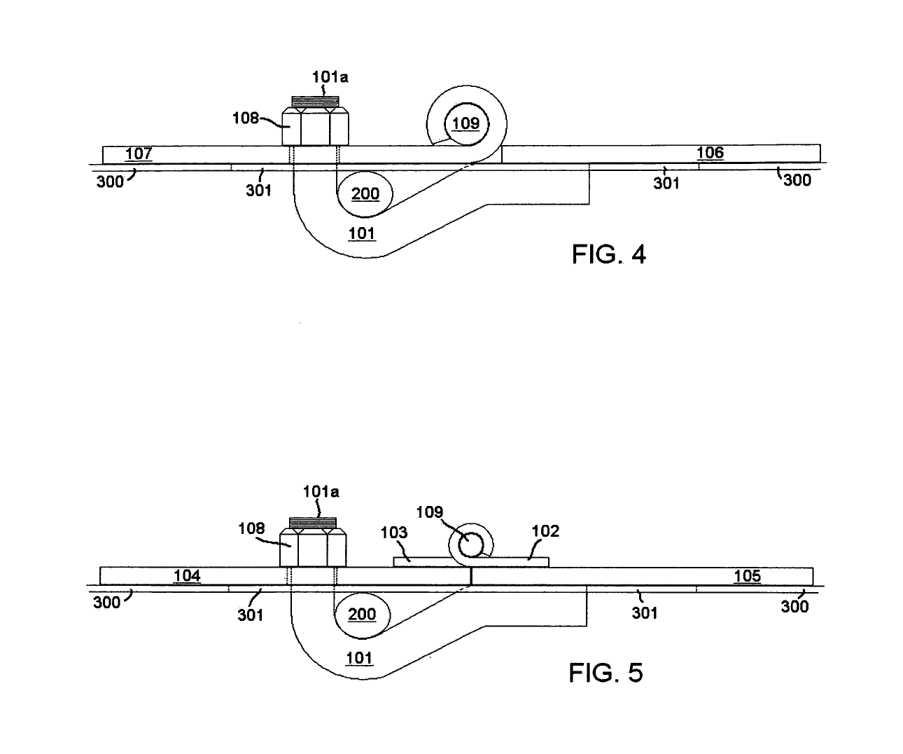

Referring to FIG. 4 there is shown the hinge plates 106 and 107 on top of the deck panel 300. The hooked rod 101 is attached to the underside of the first hinge plate 106 along the non-hooked portion of the rod 101. The hooked rod 101 is shaped to protrude below the deck panel 300 and grasp around the support cable 200 and protrude back up through the slotted opening 301 in the deck panel and through the opening in the second hinge plate 107. The protruding end of the hooked rod 101a is threaded to allow a hex nut 108 to be attached so as to temporarily secure the Hinged Fastener Clip into position securing the deck panel 300 to the support cable 200.

Referring to FIG. 5 there is shown an alternate version of the Hinged Fastener Clip of FIG. 4. The Hinged Fastener Clip of FIG. 5 there is shown hinge plates 102 and 103, and separate cover plates 104 and 105; where as the Hinged Fastener Clip of FIG. 4 combines the functions of hinge plate and cover plate into a single plate which acts as both a cover plate and a hinge plate 106 and 107. Both versions of the Hinged Fastener Clip work in the same way.

What is claimed is:

1. A pre-assembled hinged fastener clip for temporarily securing deck panels upon support cables for installation upon elevated work decks without the installer having to assemble multiple parts on the job site, the pre-assembled hinged fastener clip comprising:
a) At least two plates attached together to form a hinge.
b) A rod attached to one plate of the hinge, with said rod having a portion that is shaped as a hook and extending towards the adjoining plate of the hinge to extend through an opening in the deck panel and grasp around the support cable and then extend back up through the opening in the deck panel; with the end of said rod being threaded and extending up through a hole in the adjoining plate of the hinge.
c) A threaded nut which can be installed on to the threaded end of the hooked rod which protrudes up through the hole in the adjoining plate of the hinge so as to temporarily lock the hooked rod into the position of securing the support cable and the deck panel together.
d) The hinge/cover plates being larger then the opening in the deck panel so as to prevent the Hinged Fastener Clip from passing through the opening and to cover the opening so as to prevent debris from passing through the opening when the Hinged Fastener Clip is placed upon the deck panel over the opening in the deck panel.
